(19) United States
(12) Patent Application Publication
(10) Pub. No.: US 2023/0027379 A1
(43) Pub. Date: Jan. 26, 2023

(54) CUSTOMIZED VISUALIZATION GRID

(71) Applicant: Capital One Services, LLC, McLean, VA (US)

(72) Inventors: Gerardo FANG, El Paso, TX (US); Nicholas HERMANN, Rockledge, FL (US); Laith Obeidat, Sandy Springs, GA (US)

(73) Assignee: Capital One Services, LLC, McLean, VA (US)

(21) Appl. No.: 17/385,398

(22) Filed: Jul. 26, 2021

(51) Int. Cl. G06Q 20/40; G06N 20/00; G06Q 20/36

(52) U.S. Cl. CPC G06Q 20/401; G06N 20/00; G06Q 20/363

(57) ABSTRACT

Disclosed herein are system, method, and computer program product embodiments for generating a customized interactive transaction template based on an historical analysis of user interaction with initial transaction criteria. A user's client device displays an interactive template including initial transaction criteria. Subsequent user interactions with this interactive template are compared against historically similar interactions to select a customized range of initial transaction criteria to populate an additional interactive template to assist the user to complete the transaction.

### INCORPORATION BY REFERENCE

This application incorporates, by reference, US published application US 2020/0372574, filed May 22, 2020, entitled “Multi-lender Platform that Securely Stores Proprietary information for Pre-qualifying an Applicant”, in its entirety.

### BACKGROUND

Customized graphical user interfaces can provide graphical selections that may increase interest to a user. A number of techniques currently exist to provide customized interfaces, such as those that store/process customized graphical charts or grids on cloud-storage platforms. However, lagging behind are improvements to customized systems where a user receives a customized range of options based on historical comparisons of their behaviors to previous user interactions and associated outcomes.

### BRIEF DESCRIPTION OF THE DRAWINGS/FIGURES

FIG. 1 depicts a block diagram of a system for implementing customized financial options, according to some embodiments.

FIG. 2 depicts a block diagram illustrating generation of customized financial options, according to some embodiments.

FIG. 3 depicts a block diagram of a learning engine methodology to recognize user interaction/successful outcome patterns, according to some embodiments.

FIG. 4 depicts yet another block diagram of a learning engine methodology to recognize user interaction/successful outcome patterns, according to some embodiments.

FIG. 5 depicts yet another block diagram of a learning engine methodology to recognize user interaction/successful outcome patterns, according to some embodiments.

FIG. 6 depicts a flow diagram implementing customized financial options, according to some embodiments.

FIG. 7 depicts a graphic illustrating customized financial options based on user interactions, according to some embodiments.

FIG. 8 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for optimizing a transactional offer during an electronic shopping process. Throughout the descriptions provided herein, the terms “customer” and “user” may be used interchangeably.

This technology allows a system to capture a series of customer interactions with graphical representations of financing options contained within an offer to purchase a product. A server receives, via a client application on a client device, a user request for initial transaction criteria. The server provides, to the client device, a first interactive template including the initial transaction criteria. Subsequently, one or more user interactions with the first interactive template are returned to the server. A customized range of initial transaction criteria is selected based on an historical analysis of the one or more user interactions. A second interactive template is then generated based on the customized range of the initial transaction criteria and transmitted back to the client device where it can be displayed.

Existing mechanisms for interactively selecting financial terms, including ranges of financing options, such as term and payment, simply do not take into account the customer's specific preferences towards these terms when generating a range of financing options. In sharp contrast, typical interactive applications simply provide common ranges of loan terms (e.g., 48 or 60 months), interest rates in common increments (e.g., 2, 3, 4, 5 percent), and monthly payments also in common increments ($50 dollar changes).

In addition, car buying is typically a multi-phased process that can take months before a customer is ready to purchase a vehicle. This technology, as described herein, better optimizes a lender's resources while simultaneously reducing the stress levels of customers who may be ready to purchase a car, but simply want to browse available financing options. By providing customized financing options to the customer, based on the user's preferences or biases, a likelihood of closing a successful transaction is increased.

In view of the foregoing description and as will be further described below, the disclosed embodiments allows a customer to provide a series of interactions with financial terms of the offer that are most important to them. In addition, the described embodiments result in a novel mechanism for shopping through graphical interactions.

Various embodiments of these features will now be discussed with respect to the corresponding figures.

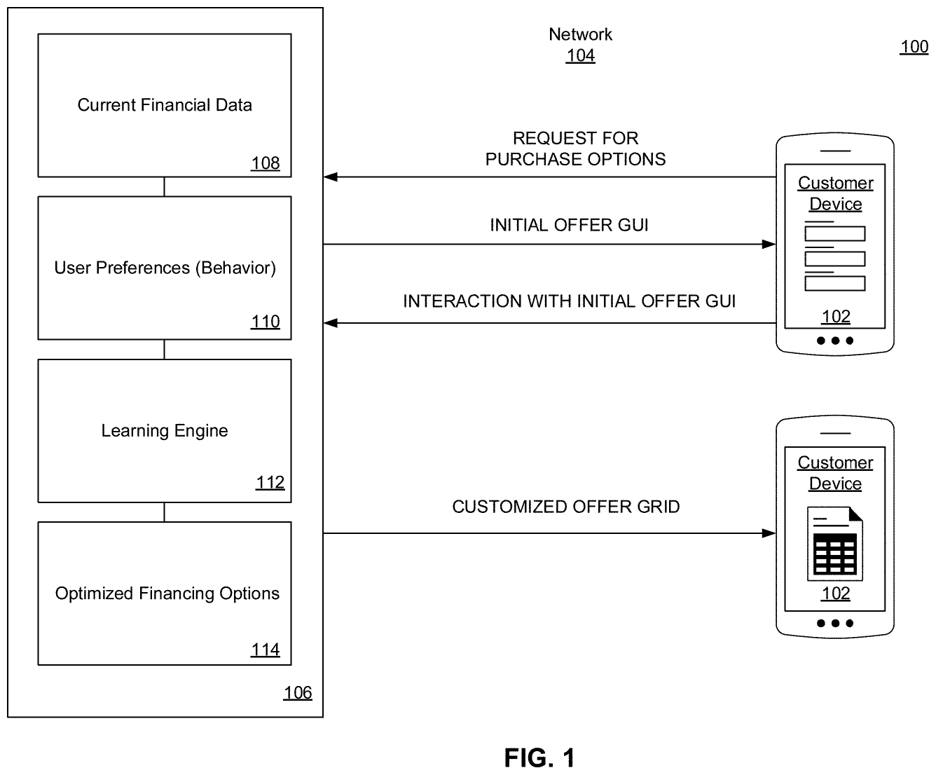

FIG. 1 depicts a block diagram of a system 100 for implementing customized financial options, according to some embodiments. System 100 may include a client device 102 (e.g., a customer mobile device) interacting with cloud processing system 106. Client device 102 may be connected to cloud processing system 106 (e.g., server platform) through wired or wireless communication networks 104.

Cloud processing system 106 may include one or more servers or databases such as a current financial data module 108 storing existing market conditions such as, but not limited to, interest rates, loan packages, lease packages, customer specific qualification information, product specific information, transaction specific information, etc. In addition, current financial information may include specific transaction information associated with a potential or existing customer such as, but not limited to, pricing, options, color, specifications (e.g., drivetrain information, horsepower, torque, length, width, height, etc.) associated with a product such as a vehicle in existing dealer inventory.

Cloud processing systems 106 may also include one or more server devices (e.g., a host server, a web server, an application server, etc.), a data center device, or a similar device, capable of communicating with client device 102 via network 104. In some embodiments, the server may be implemented as a plurality of servers that function collectively as a cloud database for storing/processing data received from client device 102. The plurality of servers can be co-located at a single location (e.g., server farm) or be geographically distributed across multiple locations and/or multiple servers.

Network 104 may include one or more wired and/or wireless networks. For example, the network 104 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

Client device 102 may include a device, such as a mobile phone (e.g., a smart phone, a radiotelephone, etc.), a laptop computer, a tablet computer, a computer workstation, a handheld computer, a gaming device, a wearable communication device (e.g., a smart wristwatch, a pair of smart eyeglasses, augmented reality headsets, interactive heads-up display (HUD), etc.), or a similar type of device. In some embodiments, client device 102 may include a location sensor used for tracking a location of client device 102. Examples of location sensors include any combination of a global position system (GPS) sensor, a digital compass, a velocitimeter (velocity meter), an accelerometer or any known or future location systems.

Client device 102 may also include an application that provides a user interface for accessing financing information associated with a specific purchase transaction. For example, the application may be implemented as an interface that allows users to interact with and otherwise select objects displayed in a real-time view provided by client device 102. In the embodiments described herein, financing decisions can be requested by interacting with a displayed graphic to determine customer preferences or biases toward one or more financing options (e.g., term, price, interest rate, monthly payments, total cost, etc.).

Client device 102 receives, via a client application, a user request for initial transaction criteria (offer) such as purchase options (price, financing information, etc.). The user request for initial transaction criteria (offer) is passed to cloud processing 106 and is processed by current financial data module 108. Current financial data module 108 collects and processes financial information about the transaction including, but not limited to, initial dealer offered pricing, market data (current interest rates, loan/lease terms, etc.), customer information (credit score, income, debts, contact information, etc.) and generates a first interactive graphic featuring one or more of these initial transaction criteria.

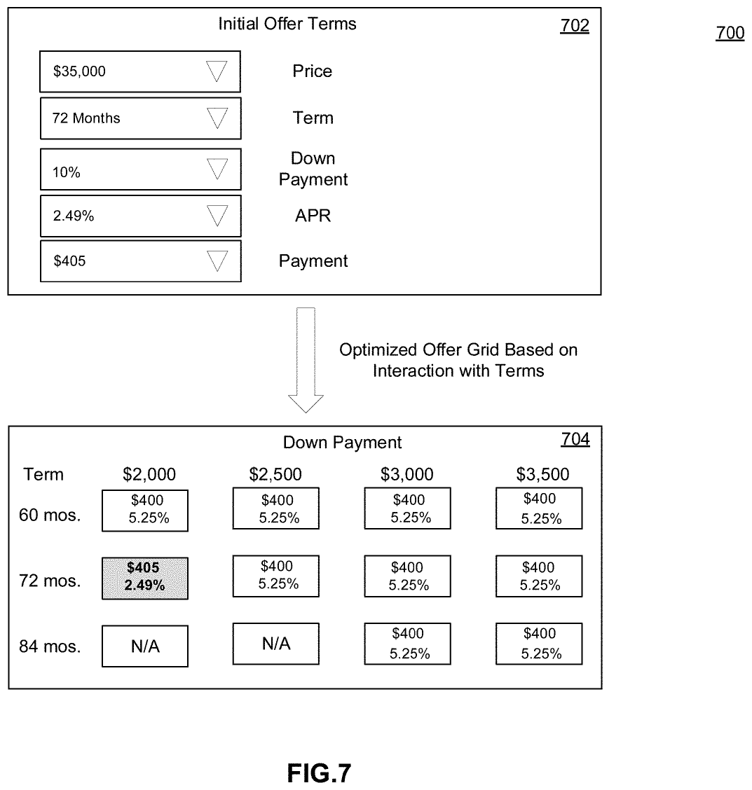

Current financial data module 108 transmits to client device 102, across network 104, the interactive graphic (first interactive template) 103 with the initial transaction criteria (such as shown in FIG. 7, element 702). The initial transaction criteria can be laid out graphically to include a series of interactive selections. For example, the customer could select a down arrow from a graphic including an initial offer, for pricing for a vehicle of choice, from the dealer. The selection of the down arrow provides a series of pricing options higher/lower in a standardized range (e.g., $250 increments). A user interacting with this graphic can choose a specific price and see a resulting recalculation of other terms associated with this transaction at the new price. For example, a lower price may result in a lower monthly payment.

In another example, the customer may select a down arrow from a graphic including an initial offer of term of the financing from a lender. The selection of the down arrow provides a series of term options higher/lower in a standardized range (e.g., 12 month increments). A user interacting with this graphic can choose a specific term and see a resulting recalculation of other terms associated with this transaction at the new term.

In another example, the customer may select a down arrow from a graphic including an initial offer of down payment for the financing from a lender. The selection of the down arrow provides a series of down payment options higher/lower in a standardized range (e.g., 5% increments). A user interacting with this graphic can choose a specific down payment and see a resulting recalculation of other terms associated with this transaction at the new down payment.

In another example, the customer may select a down arrow from a graphic including an initial offer of APR (annual percentage rate) for the financing from a lender. The selection of the down arrow provides a series of rate options higher/lower in a standardized range (e.g., 0.5% increments). A user interacting with this graphic can choose a specific APR and see a resulting recalculation of other terms associated with this transaction at the new rate.

In another example, the customer may select a down arrow from a graphic including an initial offer of monthly payment for the financing from a lender. The selection of the down arrow provides a series of monthly payment options higher/lower in a standardized range (e.g., $25 increments). A user interacting with this graphic can choose a specific monthly payment and see a resulting recalculation of other terms associated with this transaction at the new payment.

As the user interacts with the interactive graphic (first interactive template) with the initial transaction criteria, the customer device captures user interactions with the first interactive template to derive user preferences/biases to the initial transaction criteria. For example, if a user first interacts with the loan term, this may be a primary indicator that they desire a different term or monthly payment. In another example, if the user interacts with the pricing first, this may be a primary indicator that the price is too high and may potentially be a factor that could jeopardize completion of the transaction.

While single financing element interactions are fairly straightforward to decipher a user's preferences or biases, it is far more difficult to determine their preferences when they interact with multiple elements and even further if they make multiple modifications to multiple initial transaction criteria. In one embodiment, the customer's preferences are captured and returned to the cloud processing system 106 for further analysis in user preferences module 110. In an alternate embodiment, the customer's preferences are captured and analyzed locally on the client device 102.

The analysis of the customer interactions includes comparing the customer's behavior to historic transactions to identify previously successful transactions with similar instances of the user interactions. For example, if historically, user interaction with a specific transaction or combination of specific transaction criteria results in a successful transaction, then that analysis may assist in moving the offer in a direction favoring those preferences.

Cloud processing system 106 includes user preferences module 110 capturing customer interactions (behaviors) with the first interactive template in coaction with learning engine 112 configured to implement historical comparing of customer interactions by any of: machine learning, artificial intelligence (AI), deep learning, neural network, or fuzzy logic.

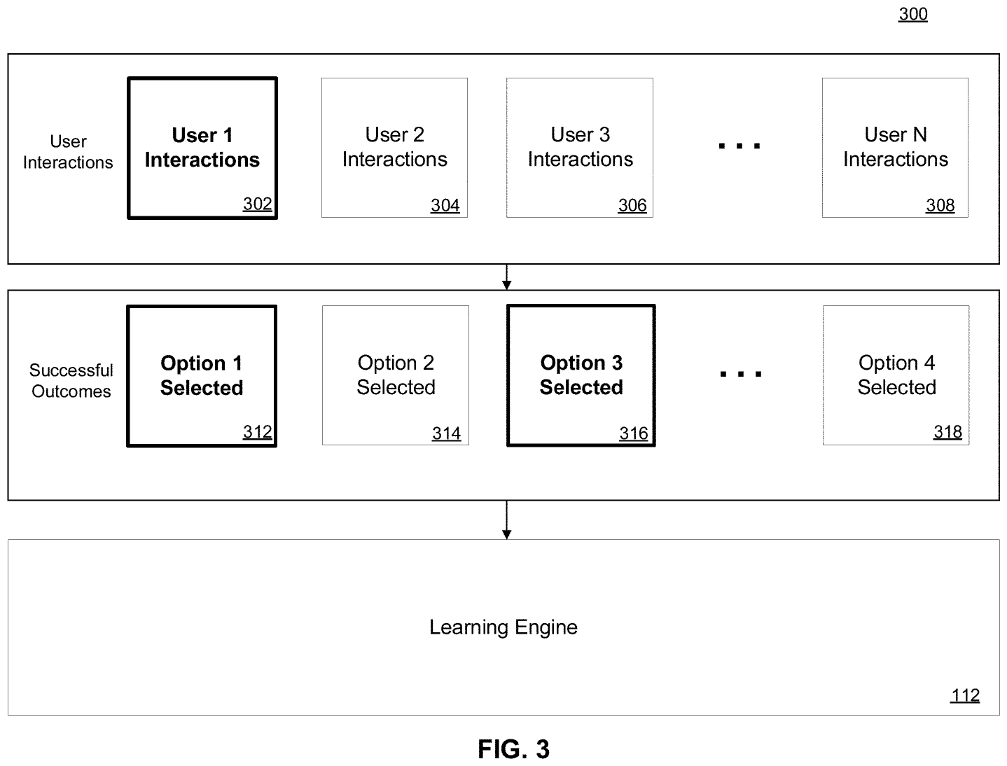

Machine learning (ML) is the study of computer algorithms that improve automatically through experience. It is seen as a part of artificial intelligence. Machine learning algorithms build a model based on sample data, known as “training data” (See FIGS. 3-5), in order to make predictions or decisions without being explicitly programmed to do so.

A subset of machine learning is closely related to computational statistics, which focuses on making predictions using computers. The study of mathematical optimization delivers methods, theory and application domains to the field of machine learning. In its application across business problems, machine learning is also referred to as predictive analytics.

Machine learning approaches are traditionally divided into various categories, depending on the nature of the feedback available to the learning system. For example, for supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

In one example embodiment, a training set includes a large set of previous user interactions with initial transaction criteria. Learning engine 112 processes the training set to recognize patterns of behavior that result in successful outcomes. Once the learning engine has recognized a range of patterns of behavior that result in successful behavior, it can take as an input any future behavior and correlate to determine a higher likelihood of successful outcome by modifying the initial transaction criteria to include customized ranges.

Optimized financing options module 114 subsequently generates a second interactive template 116 based on the customized ranges of financial options and returns this second interactive template to the client device where it can be displayed.

In an additional embodiment, client device 102 may send customer selections from the second interactive template back to the cloud based system for completion of the transaction. For example, the cloud based system completes a contract for purchase using the selected transaction criteria. This transaction processing can occur on a server located in cloud processing system 106 or on a separate or remotely located financial server. In addition, the customer interactions with the second interactive template 116, financial terms and outcomes of the transaction (e.g., successful purchase, no purchase) can be fed back into the user preferences and learning engine modules to provide additional training inputs to improve future predictive performance.

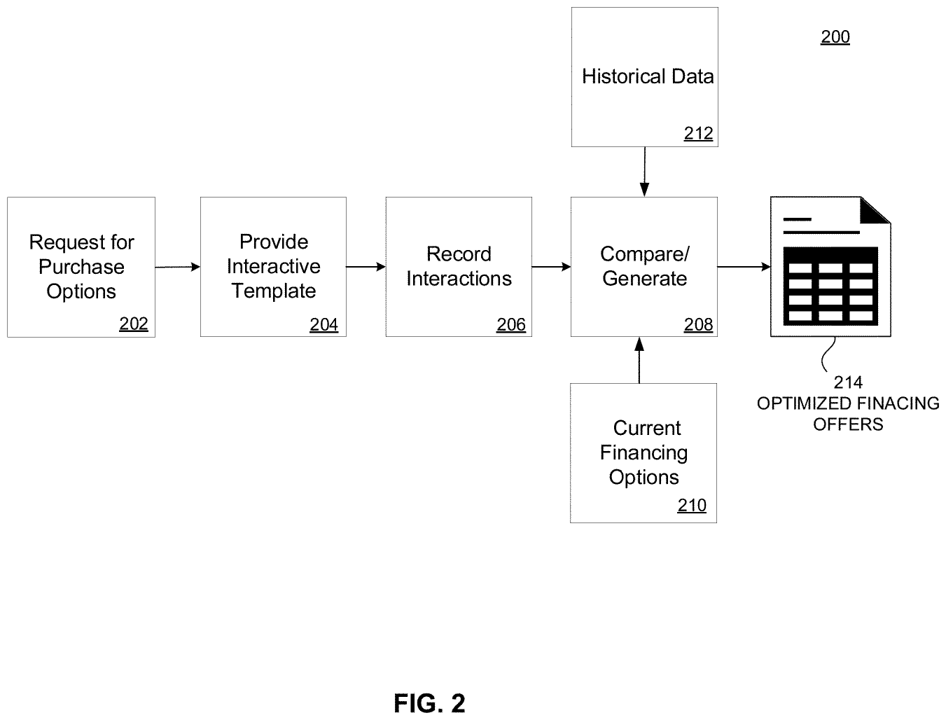

FIG. 2 depicts a block diagram 200 illustrating generation of customized financial options, according to some embodiments. In some embodiments, client device 102 represents an implementation as a mobile device as shown in FIG. 1 and may include a GUI (graphical user interface), for example, provided by an image application.

In this embodiment, client device 102 may display graphics, grids, charts, lists, selectable icons, menus etc. to a customer to upload additional data, associate features with a potential purchase, assist in completing a purchase transaction, just to name a few examples.

In block 202, a request for purchase options is initiated by a user of client device 102 via a client application and is received by remote financial processing systems, for example, cloud processing system 106.

In block 204, remote financial processing systems provide, to the client device 102, a first interactive template including initial transaction criteria as part of a first offer (e.g., from a car dealer on a specific vehicle of interest). In one example, the first interactive template includes a graphical list structure as shown in FIG. 7, element 702. As shown, the initial offer terms include, but are not limited to, “price”, “term”, “down payment”, “APR (annual percentage rate)” and “payment”.

In block 206, one or more user interactions with the first interactive template are recorded (locally or on remote financial processing systems), aggregated and stored in computer storage for further processing.

In block 208, the one or more user interactions with the first interactive template are compared using learning engine functionality (described in greater detail hereafter). The comparison is performed against historical data 212 of previous user interactions and resulting actions taken. In one embodiment, current financing options 210 are also used to focus/enhance the compare functionality. For example, previous user interactions of highest interest may be those that occur with similar financing options. A user of specific qualifications may be compared against a subset of historical interactions of similarly qualified customers. In another example, a vehicle in a specific price range may be compared against a subset of historical interactions of similarly priced vehicles. In yet another example,

an available loan rate (APR) may be compared against a subset of historical interactions of similarly available loan rates. Therefore, the current financing options are used to fine tune the learning engine historical data inputs. While described specifically for current financing options, additional criteria may be used to fine tune the compare, such as subsets of similar: personal information (income, credit rating, etc.), geographical data, dealer specific historical data, or type of vehicle historical data (truck, car, motorcycle, commercial fleet, etc.). These subsets of non-financial data or equivalents can be used without departing from the scope of the technology described herein.

In addition, in block 208, based on at least the historical analysis of the one or more user interactions, a customized range of the initial transaction criteria is generated and a second interactive template 214 is generated and populated with the customized range of options. (e.g., see FIG. 7, element 704). For example, the customized range of options is displayed as an interactive grid of options deemed preferential to the customer. By customizing the grid of options, the likelihood of a successful transaction is increased. A customer selecting a specific option initiates a process to draft a contract with financial features including at least the specific selected options.

FIGS. 3-5 depict block diagrams of a learning engine methodology to recognize user interaction/successful outcome patterns, according to some embodiments. As a non-limiting example with regards to FIGS. 1 and 2, one or more processes described with respect to FIG. 3 may be performed by a mobile device (e.g., client device 102 of FIG. 1) or a server (e.g., part of cloud processing systems 106 of FIG. 1) for analyzing financial purchase information associated with user interaction with graphically displayed financing elements. In embodiment 300, mobile device 102 and/or the server may execute code in memory to perform certain steps associated with FIGS. 1-7. The GUI application determines whether the requested data is stored locally (e.g., mobile device memory) or remotely (e.g., cloud-based financial platform).

If stored remotely, a file request (identifying the requested file) and the retrieved interaction information and financing element information are retrieved from the remote location for further processing. If stored locally, a learning application processes the financial data request based on the user interactions with a GUI. Financial information, such as customer profile data, prequalification, credit rating, or maximum loan available may be pre-stored in advance of a potential purchase with live information (during user interactions) such as specific financing information and dealer incentive programs added to assist in calculating financing options to complete an offer for financing.

Machine learning algorithms build a model based on sample data, known as “training data”, in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

In one example embodiment, a training set includes a large set of N previous user interactions (302, 304, 306, and 308) with initial transaction criteria. Learning engine 320 (112 in FIG. 1) processes the training set to recognize patterns of behavior that previously resulted in successful outcomes based on options selected (312-318). Once the learning engine has recognized patterns of behavior that result in successful behavior, it can take as an input any future behavior and correlate to determine a higher likelihood of successful outcome by modifying the initial transaction criteria to include customized ranges within the subset of successful outcomes.

As shown in FIG. 3, a first user (User 1) interacts with financing elements displayed on a GUI. The user interactions, for example, may include a customer modifying an initial offer of term for the financing from a lender. The modifying may subsequently provide a series of term options higher/lower in a standardized range (e.g., 12 month increments). A user interacting with this graphic can choose a specific term and see a resulting recalculation of other terms associated with this transaction at the new term. Each time a user repeats a similar subset of interactions and produces a similar successful final result, this pattern is learned and strengthened as a more likely outcome. Each time a user repeats a similar subset of interactions and produces a different successful final result or an unsuccessful outcome, the result is recognized as a less likely outcome. By feeding a large training set (e.g., many thousands) of possible user interactions and associated successful outcomes into the learning engine, the system can guess the most likely successful outcome or a range of likely outcomes. Using this knowledge, a knowledge database (not shown) is created—one that is improved for accuracy with each new set of inputs and outcomes.

In an embodiment, the system then modifies the initial transaction criteria by creating a range of potentially higher success criteria to match the user preferences discerned by the learning engine when comparing their interactions with those that are similar (e.g., contain a plurality of same selections). In one example, a customer receives an initial offer with a price of $30,000, term of 60 months, APR of 3.5% and payment of $450. When interacting with a GUI displaying these changeable transaction criteria, the user changes the term and APR. The system feeds these interactions into the learning engine where they are compared against historically similar interactions, and identifies a range of successful outcomes associated with this pattern of behavior. For example, previous customers focused on these two criteria typically close the transaction (purchase) when the final monthly price falls within $390-$440. The system may also identify interactions that are dominant and weigh them higher in an analysis. For example, the customer changes the term first or changes it multiple times while changing the APR second or only once. While this example represents a simple analysis, the learning engine can detect patterns of thousands (or more) of interaction combinations and thus recognize complex patterns of behavior.

In FIG. 3, User 1 ultimately selected option 1 (e.g., term) 312 and option 3 (e.g., APR) 316 in completing a successful transaction (purchase) after interacting with the first template of initial financial criteria (User 1 interactions 302).

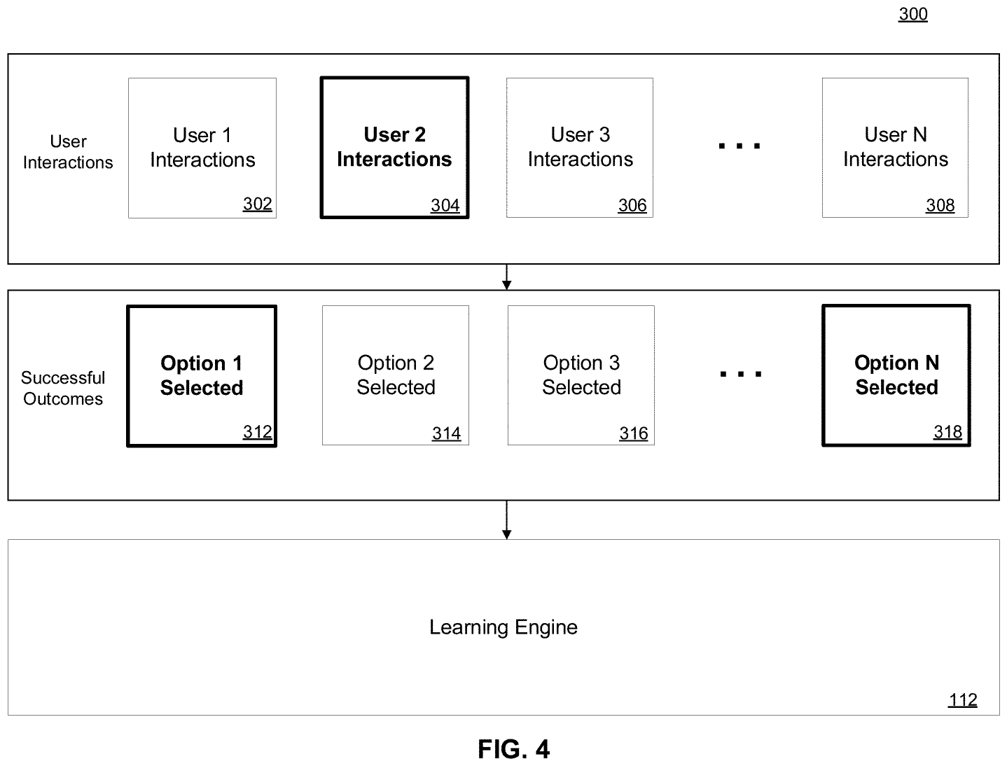

In FIG. 4, User 2 ultimately selected option 1 (e.g., term) 312 and option N (e.g., specific price) 318 in completing a successful transaction (purchase) after interacting with the first template of initial financial criteria (User 2 interactions 304).

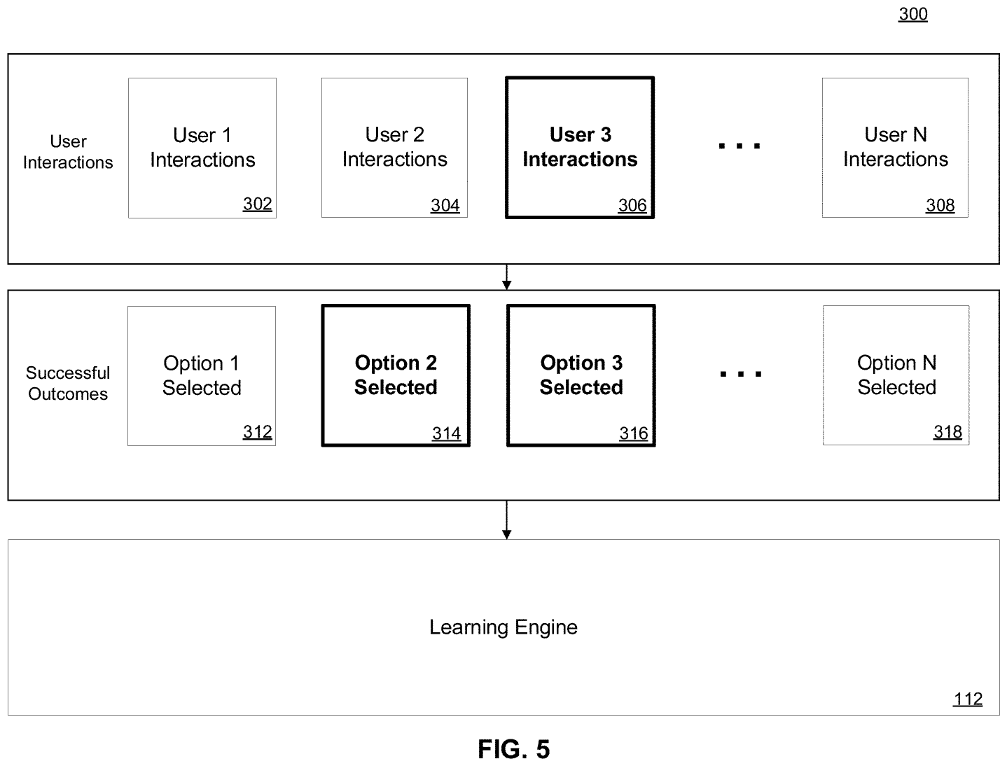

In FIG. 5, User 3 ultimately selected option 2 (e.g., monthly payment) 314 and option 3 (e.g., APR) 316 in completing a successful transaction (purchase) after interacting with the first template of initial financial criteria (User 3 interactions 306).

Over time, the repeated correlation of specific user interactions with options chosen resulting in a successful outcome (purchase) will improve the learning engine's ability to predict a range of options or a range of combinations of options that will improve the likelihood of a successful transaction and generate a second GUI template (e.g., see FIG. 7, element 704) displaying this range of options. A user is more likely to find appealing options in this customized range of options and make a selection that ultimately closes the transaction, thus improving a lender's successful close rate while providing the customer a better experience by accounting for their specific preferences.

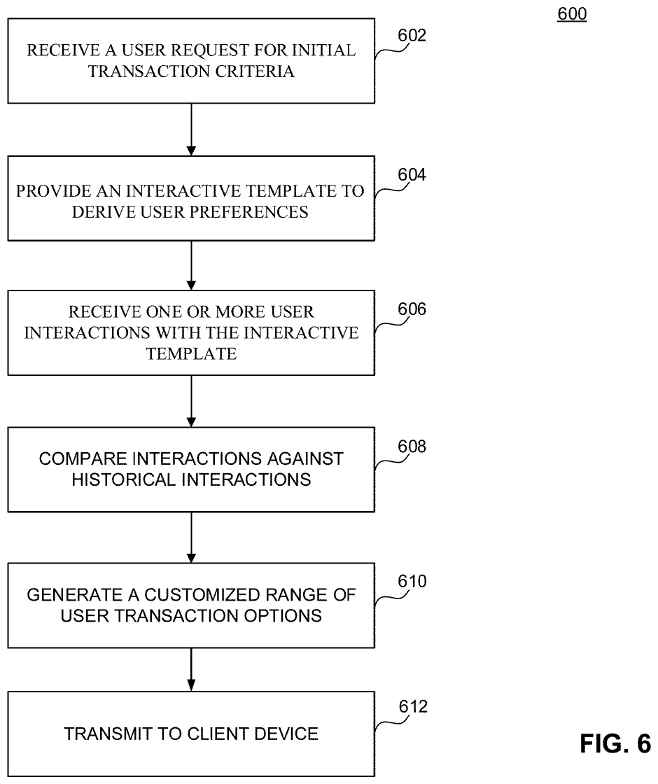

FIG. 6 depicts a flow diagram of an example method 600 implementing customized financial options, according to some embodiments.

As a non-limiting example with regards to FIGS. 1-7 one or more processes described with respect to FIG. 6 may be performed by a mobile device (e.g., client device 102 of FIG. 1) or a server (e.g., part of cloud processing systems 106 of FIG. 1) for analyzing financial purchase information associated with user interaction with graphically displayed financing elements. In embodiment 600, client device 102 and/or the server may execute code in memory to perform certain steps associated with FIGS. 1-7. The GUI application determines whether the requested data is stored locally (e.g., mobile device memory) or remotely (e.g., cloud-based financial platform).

While method 600 will be discussed below as being performed by a mobile device and/or server, other devices may store the code and therefore may execute method 600 by directly executing the code. Moreover, it is to be appreciated that not all steps may be needed to perform the disclosure provided herein. Further, some of the steps may be performed simultaneously or in a different order than shown in FIG. 6, as will be understood by a person of ordinary skill in the art.

In step 602, cloud processing system 106 receives, via a client application on client device 102, a user request for an initial offer including any initial transaction criteria. The request will result in an offer being provided by a seller of the product (e.g., a dealer for a vehicle) and include a variety of initial transaction criteria such as price, term, rate, monthly payment, etc.

In step 604, cloud processing system 106, provides to client device 102, a first interactive template including the initial transaction criteria. The interactive template allows the requestor to modify the initial transaction criteria. For example, the first interactive template includes a graphical list structure as shown in FIG. 7, element 702. As shown, the initial offer criteria (terms) include, but are not limited to, “price”, “term”, “down payment”, “APR (annual percentage rate)” and “payment”.

In step 606, user interactions with the first interactive template are captured to derive user preferences/biases to the initial transaction criteria. For example, the user modifies the term. One or more user interactions with the first interactive template are captured (recorded locally or on remote financial processing systems), aggregated and stored in computer storage for further processing.

In step 608, cloud processing system 106, compares the user interactions to historic transactions to identify previously successful transactions with similar instances of the user interactions. As described herein, the learning engine compares the user interactions with similar previous user interactions with successful outcomes. In one embodiment, current financing options are also used to focus the compare functionality. For example, a vehicle in a specific price range may be compared against a subset of historical interactions of similarly priced vehicles.

While described specifically for current financing options, additional criteria may be used to fine tune the compare functionality, such as subsets of similar: personal information (income, credit rating, etc.), geographical data, dealer specific historical data, and type of vehicle historical data (truck, car, motorcycle, commercial fleet, etc.) without departing from the scope of the technology described herein.

In step 610, cloud processing system 106, generates a customized range of the initial transaction criteria based on a range of transaction criteria values associated with the previously successful transactions and populates a second interactive template with the customized range of transaction values. By customizing the grid of financial options, the likelihood of a successful transaction is increased. A customer selecting a specific option initiates a process to draft a contract with financial features including at least the specific option.

In step 612, cloud processing system 106, transmits a second interactive template based on the customized range. For example, the system transmits the graphic grid of financing options (See FIG. 7, element 704) to be displayed on client device 102.

FIG. 7 depicts another flow diagram illustrating a flow of a customer shopping process, according to some embodiments. As a non-limiting example with regards to FIGS. 1-7 one or more processes described with respect to FIG. 7 may be performed by a mobile device (e.g., client device 102 of FIG. 1) or a server (e.g., part of cloud processing systems 106 of FIG. 1) for analyzing financial purchase information associated with user interaction with graphically displayed financing elements. In embodiment 700, client device 102 and/or the server may execute code in memory to perform certain steps associated with FIGS. 1-7. The GUI application determines whether the requested data is stored locally (e.g., mobile device memory) or remotely (e.g., cloud-based financial platform).

While method 700 will be discussed below as being performed by mobile device 102 and/or server, other computer-based devices may store the code and therefore may execute method 700 by directly executing the code. Moreover, it is to be appreciated that not all steps may be needed to perform the disclosure provided herein. Further, some of the steps may be performed simultaneously or in a different order than shown in FIG. 7, as will be understood by a person of ordinary skill in the art.

A first interactive template 702 includes a series of terms of an initial offer made by the seller in conjunction with the lender. As shown, the initial offer terms include, but are not limited to, “price”, “term”, “down payment”, “APR (annual percentage rate)” and “payment”. Any transaction criteria can be substituted without departing from the scope of the technology described herein. For example, additional transaction criteria may include interest paid per month, total interest, total payments, total costs, amount of time the offer is valid, etc.

A user interacts with the first interactive template 702 by selecting a criteria and modifying that criteria. For example, the customer could select a down arrow from a graphic including an initial offer, for pricing for a vehicle of choice, from the dealer. The selection of the down arrow provides a series of pricing options higher/lower in a standardized range (e.g., $250 increments). A user interacting with this graphic can choose a specific price and see a resulting recalculation of other terms associated with this transaction at the new price. For example, a lower price may result in a lower monthly payment.

In another example, the customer could select a down arrow from a graphic including an initial offer of term for the financing from a lender. The selection of the down arrow provides a series of term options higher/lower in a standardized range (e.g., 12 month increments). A user interacting with this graphic can choose a specific term and see a resulting recalculation of other terms associated with this transaction at the new term.

In another example, the customer could select a down arrow from a graphic including an initial offer of down payment for the financing from a lender. The selection of the down arrow provides a series of down payment options higher/lower in a standardized range (e.g., 5% increments). A user interacting with this graphic can choose a specific down payment and see a resulting recalculation of other terms associated with this transaction at the new term.

In another example, the customer could select a down arrow from a graphic including an initial offer of APR (annual percentage rate) for the financing from a lender. The selection of the down arrow provides a series of rate options higher/lower in a standardized range (e.g., 0.5% increments). A user interacting with this graphic can choose a specific APR and see a resulting recalculation of other terms associated with this transaction at the new term.

In another example, the customer could select a down arrow from a graphic including an initial offer of monthly payment for the financing from a lender. The selection of the down arrow provides a series of monthly payment options higher/lower in a standardized range (e.g., $20 increments). A user interacting with this graphic can choose a specific monthly payment and see a resulting recalculation of other terms associated with this transaction at the new term.

Once the system captures the user interaction with the first interactive template 702, the system compares these interactions against historically similar interactions and produces a second interactive template 704 with a customized range of transaction criteria based on the user interactions.

Second interactive template 704 is shown as a grid of finely tuned (customized) range of options set in a graphical format. For example, as shown, a range of $2,000-$3,500 in down payment and a range of term from 60-84 months is provided in the grid. While shown as a grid, any known or future graphical format including the customized range of transaction criteria options can be substituted without departing from the scope of the technology described herein. In addition, other display methods, such as hologram, wearable technology, audio equivalency, complex charting, icon-based GUIs, etc. are also considered within the scope of the technology described herein.

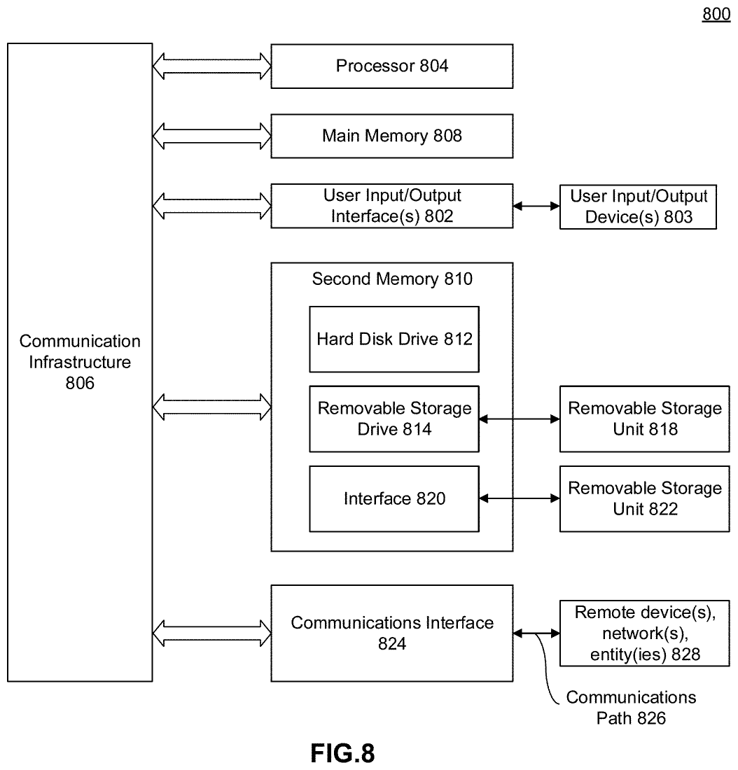

Various embodiments (as described in conjunction with FIGS. 1-7) may be implemented, for example, using one or more well-known computer systems, such as computer system 800 shown in FIG. 8. One or more computer systems 800 may be used, for example, to implement any of the embodiments discussed herein, as well as combinations and sub-combinations thereof. Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
receiving, at a server and via a client application on a client device, a user request for initial transaction criteria;
providing, to the client device, a first interactive template including the initial transaction criteria;
receiving, at the server, one or more user interactions with the first interactive template;
selecting, based on an historical analysis of the one or more user interactions, a customized range of the initial transaction criteria;
generating, at the server, a second interactive template based on the customized range of the initial transaction criteria;
transmitting, to the client device, the second interactive template; and
wherein the second interactive template can be displayed on the client device.

2. The method of claim 1, wherein the one or more user interactions with the first interactive template reflect user preferences of the initial transaction criteria.

3. The method of claim 2, wherein the first interactive template includes modifiable data fields representing the initial transaction criteria.

4. The method of claim 1, wherein the second interactive template includes a graphical grid of the customized range of the initial transaction criteria.

5. The method of claim 1, wherein the one or more user interactions with the first interactive template include specific user selections from a set of user selections.

6. The method of claim 1, wherein the historical analysis includes at least a partial analysis by any of: artificial intelligence (AI), machine learning, deep learning, neural network, or fuzzy logic.

7. The method of claim 1, wherein the historical analysis includes analyzing previous other user interactions.

8. The method of claim 7, wherein the historical analysis includes comparing the previous other user interactions with the one or more user interactions.

9. The method of claim 8, wherein the historical analysis further includes comparing previous other user interactions resulting in successful transactions based at least partially on the one or more user interactions.

10. The method of claim 9, wherein the historical analysis further includes filtering previously successful transactions based on a similarity with the one or more user interactions.

11. The method of claim 10, wherein the customized range is selected from a range of values associated with the filtered previously successful transactions.

12. The method of claim 11, wherein the second interactive template includes a graphical grid of an optimized range of the initial transaction criteria based on the historical analysis.

13. A system comprising:
a host server having a processor communicatively coupled to a memory, the processor configured to:
receive, via a client application on a client device, a user request for initial transaction criteria;
provide, to the client device, a first interactive template including the initial transaction criteria;
capture user interactions with the first interactive template to derive user biases to the initial transaction criteria;
compare the user interactions to historic transactions to identify previously successful transactions with similar instances of the user interactions;
select a customized range of the initial transaction criteria based on a range of transaction criteria values associated with the previously successful transactions;
generate a second interactive template based on the customized range;
transmit, to the client device, the second interactive template; and
wherein the second interactive template can be displayed on the client device.

14. The system of claim 15, wherein the second interactive template includes a graphical grid of the customized range of the initial transaction criteria.

15. The system of claim 14, wherein the interactive grid is selectable by the user to assist in completing the initial transaction.

16. The system of claim 15, wherein the processor is further configured to implement the compare by any of: artificial intelligence (AI), machine learning, deep learning, neural network, or fuzzy logic.

17. A non-transitory computer readable medium storing instructions that when executed by one or more processors of a device cause the one or more processors to:
receive, via a client application on a client device, a user request for initial transaction criteria;
provide, to the client device, a first interactive template to derive user preferences of the initial transaction criteria;
receive one or more user interactions with the first interactive template;
select, based on an historical analysis of similar instances of the one or more user interactions, a customized range of the initial transaction criteria;
generate a second interactive template based on the customized range of the initial transaction criteria;
transmit, to the client device, the second interactive template; and
wherein the second interactive template can be displayed on the client device.

18. The non-transitory computer readable medium of claim 17, wherein the second interactive template is configured as an interactive grid of the customized range of the initial transaction criteria.

19. The non-transitory computer readable medium of claim 17, wherein the interactive grid is selectable by the user to assist in completing the initial transaction.

20. The non-transitory computer readable medium of claim 17, wherein the instructions further cause the one or more processors to select the customized range by any of: artificial intelligence (AI), machine learning, deep learning, neural network, or fuzzy logic.
